(19) United States
(12) Patent Application Publication
(10) Pub. No.: US 2016/0343040 A1
(43) Pub. Date: Nov. 24, 2016

(54) SOCIAL MEDIA ENHANCEMENT

(71) Applicant: SPRINKLR, INC., New York, NY (US)

(72) Inventors: Justin Trevor Garrity, New York, NY (US); Ryan Robert Parr, New York, NY (US); David James Stewart, New York, NY (US)

(73) Assignee: SPRINKLR, INC., New York, NY (US)

(21) Appl. No.: 15/160,694

(22) Filed: May 20, 2016

Related U.S. Application Data
(60) Provisional application No. 62/165,479, filed on May 22, 2015.

(51) Int. Cl. G06Q 30/02; G06Q 50/00; H04L 29/08

(52) U.S. Cl. CPC G06Q 30/0276; H04L 67/10; G06Q 50/01; G06Q 30/0277

(57) ABSTRACT

A social media processing system enhances posts to create stronger visual connections with viewers. The processing system may collect social media from different social networks and identify social streams from the social media associated with a particular client. The processing system stores a data set associated with the client that may include keywords, rules, and associated enhancements. The enhancements may include logos, images, font types, statistics, or any other information associated with the company. The processing system identifies content in the posts matching the keywords and adds the enhancements associated with the matching keywords to the post.

### CROSS-REFERENCE TO RELATED APPLICATION

This application claims priority from U.S. Provisional Patent Application No. 62/165,479, filed May 22, 2015, the entire disclosure of which is incorporated herein by reference.

### BACKGROUND

Users post messages on social networks about people, products, and services. Users may engage with the posts from other users by commenting, indicating that they like the post, or rebroadcasting the post to their friends and followers. Companies try and use this social media to promote their products and services. For example, a company may launch a campaign to sell a particular product. The company monitors social media accounts and use positive consumer posts as endorsements for the product.

Social media endorsements may have a large positive impact on sales since the posts are generated from supposedly non-biased consumers. However, posts on social networks have a generic text format and consumers may not readily distinguish the subject matter, context, or products associated with the posts. Thus, companies may not utilize the full potential of social media endorsements.

### BRIEF DESCRIPTION OF THE DRAWINGS

FIG. 1 depicts an example social media processing system.

FIG. 2 depicts example enhancements added to different posts.

FIG. 3 depicts additional example enhancements added to posts.

FIG. 4 depicts an example process for the social media processing system of FIG. 1.

FIG. 5 depicts an example process for enhancing posts.

FIG. 6 depicts an example process for enhancing posts associated with an event.

FIG. 7 depicts an example computing device used in the social media processing system.

### DETAILED DESCRIPTION

A social media processing system enhances social media posts to create stronger visual connections with viewers. The processing system may collect social media from different social networks and identify social streams from the social media associated with a particular client. For example, the processing system may identify all of the posts on a particular company account or that mention the company.

The processing system stores a data set associated with the client that may include keywords, rules, and associated enhancements. The enhancements may include logos, images, font types, statistics, or any other information associated with the client. The processing system identifies content in the posts matching the keywords and adds the enhancements associated with the matching keywords to the post.

For example, the processing system may identify the name of the company in the post and add an associated company logo. In another example, the processing system may identify a name of a person or product affiliated with the company and add a picture to the person or product to the post.

In another example, the processing system may have a set of generic enhancements for adding to all posts regardless of the client affiliation. For example, the processing system may identify positive words in the post and add an associated positive image, such as a heart or smile. The enhancements may create stronger connections between company products and consumers since the posts include both personal endorsements and visual images and information for any associated company products.

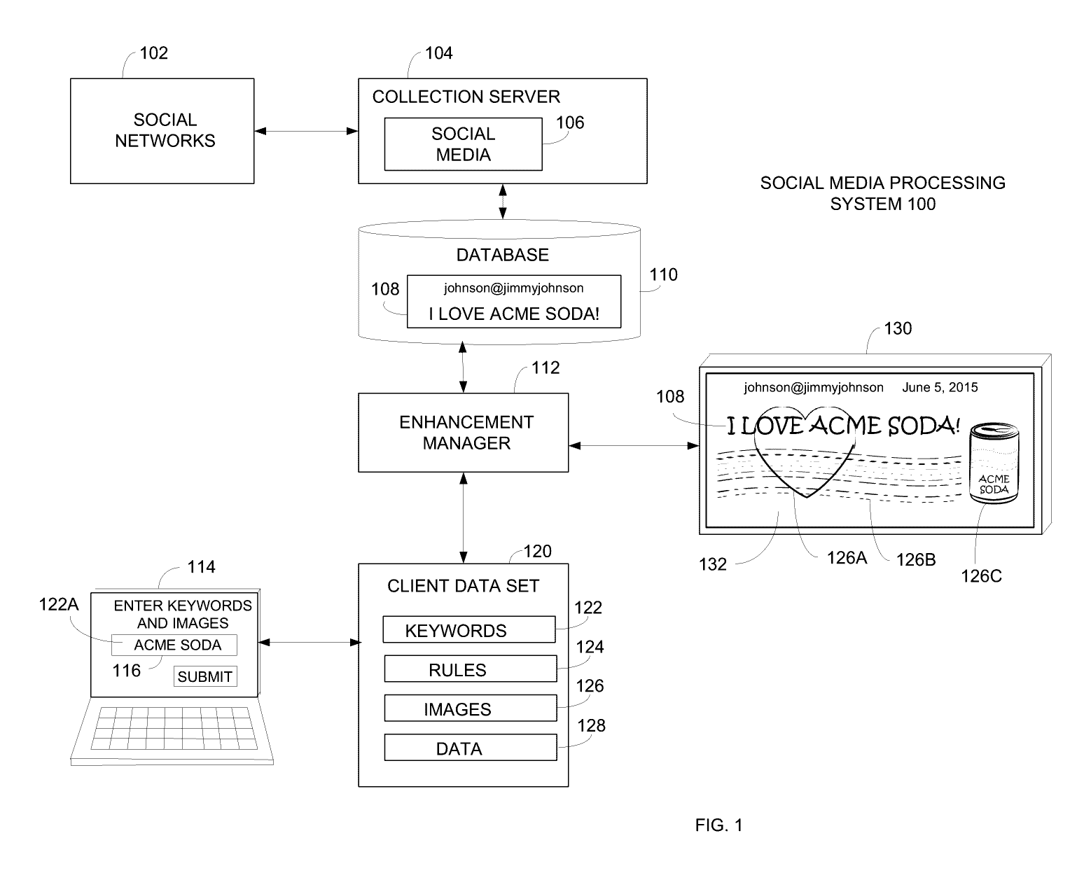

FIG. 1 shows an example social media processing system (processing system) 100. A collection server 104 accesses different social networks 102, such as Twitter®, Facebook®, Instagram®, Google®, or any other website associated with a company, individual, or any other entity. Collection server 104 collects and stores social media 106 from social networks 102 in database 110. Social media 106 may include messages, tweets, pictures, images, audio, video, text, posts, or any other data.

A data set 120 may include any combination of keywords 122, rules 124, images 126, or any other data 128. A user may create data set 120 via a user device 114, such as a portable notebook, portable tablet, or personal computer 102. The user may create a data set associated with a particular company. For example, the user may add a keyword 122A such as Acme Soda into a field 116 displayed on the screen of user device 114.

The user may enter and associate one or more rules 124, images 126, and/or any other data 128 with keywords 122. For example, the client may create a rule 124 that associates the keyword Acme Soda with an Acme Soda logo 126B and an image of an Acme Soda can 126C.

An enhancement manager 112 may operate in an application server within processing system 100 and enhance social media 106 based on data set 120. Enhancement manager 112 may identify social streams in social media 106 associated with the Acme Company. For example, enhancement manager 112 may identify messages within social media 106 sent to a @Acme social network account or that include a #Acme hashtag.

Enhancement manager 112 may curate the identified messages for rendering on a display screen 130. For example, enhancement manager 112 may filter out derogatory or obscene messages and/or identify messages with positive comments regarding Acme Soda.

In one example, enhancement manager 112 identifies a message 108 that includes the text: I LOVE ACME SODA. Enhancement manager 112 compares the words in message 108 with keywords 122 in data set 120. In this example, the term Acme Soda in message 108A matches keyword 122A in data set 120. Enhancement manager 120 identifies images 126B and 126C in data set 120 specified by rules 124 associated with the matching keyword 122A. Enhancement manager 112 adds images 126B and 126C as enhancements to message 108 and displays both as enhanced post 132 on display screen 130.

Data set 120 may associate other keywords 122 with other images 126. For example, the user may associate another image 126A in data set 120 with the keyword LOVE. Enhancement manager 112 then may identify the additional word LOVE in message 108 and add the associated image 126A prior to rendering enhanced message 132 on display screen 130.

Enhancement manager 112 may add other data 128 from data set 120 to message 108, such as a price of the product and/or a location for purchasing the product mentioned in message 108. Data 128 in data set 120 also may identify different fonts and font sizes for associated keywords 122. For example, data 128 may identify a font used on Acme Soda cans. Enhancement manager 112 may further enhance message 108 by changing the font originally used in message 108 to the font used on Acme soda cans.

Enhancement manager 112 also may identify images contained in message 108. For example, a user may post a message that includes a company logo. Data set 120 may include the logo as part of keywords 122 and enhancement manager 112 may use an image detection system to detect any messages 108 that contain the logo. Enhancement manager 112 then may include a rule and associated images and/or data for adding to message 108 based on the detected logo.

Enhancements 126 increase the visual connection of a product mentioned in post 108 with viewers. For example, logo 126B and soda can 126C immediately connect viewers with Acme Soda. In addition, heart image 126A immediately notifies viewers that message 108 is a positive endorsement of Acme Soda. Thus, enhanced message 132 combines the increased visual impact and viewer association of images 126 with the user endorsement contained in message 108.

The same or different data sets 120 may include different keywords 122, rules 124, images 126, and data 128 for different products, services, and events. For example, a first set of keywords 122, rules 124, and images 126 may be associated with a first type of soda and a second set of keywords 122, rules 124, and images 126 may be associated with a second type of soda. A third set of keywords 122, rules 124, and images 126 may be associated with a particular campaign or event associated with Acme Soda, such as an athletic event or concert.

Processing system 100 may associated different data sets 120 with different clients. For example, a first dataset 120 may contain the keywords, rules, image and/or data for a clothes manufacturer and a second dataset 120 may contain the keywords, rules, image and/or data for a movie studio. Users via user device 114 or datasets 120 may identify which social media streams for applying to different data sets 120.

In another example, processing system 100 may include multiple display screens 130 and a different data set 120 or group of rules in a same data set 120 may be associated with each display screen. For example, the multiple display screens 130 may be located in a sports stadium and enhancement manager 112 may displayed enhanced messages 132 on each of display screens 130 associated with different players from a sports team.

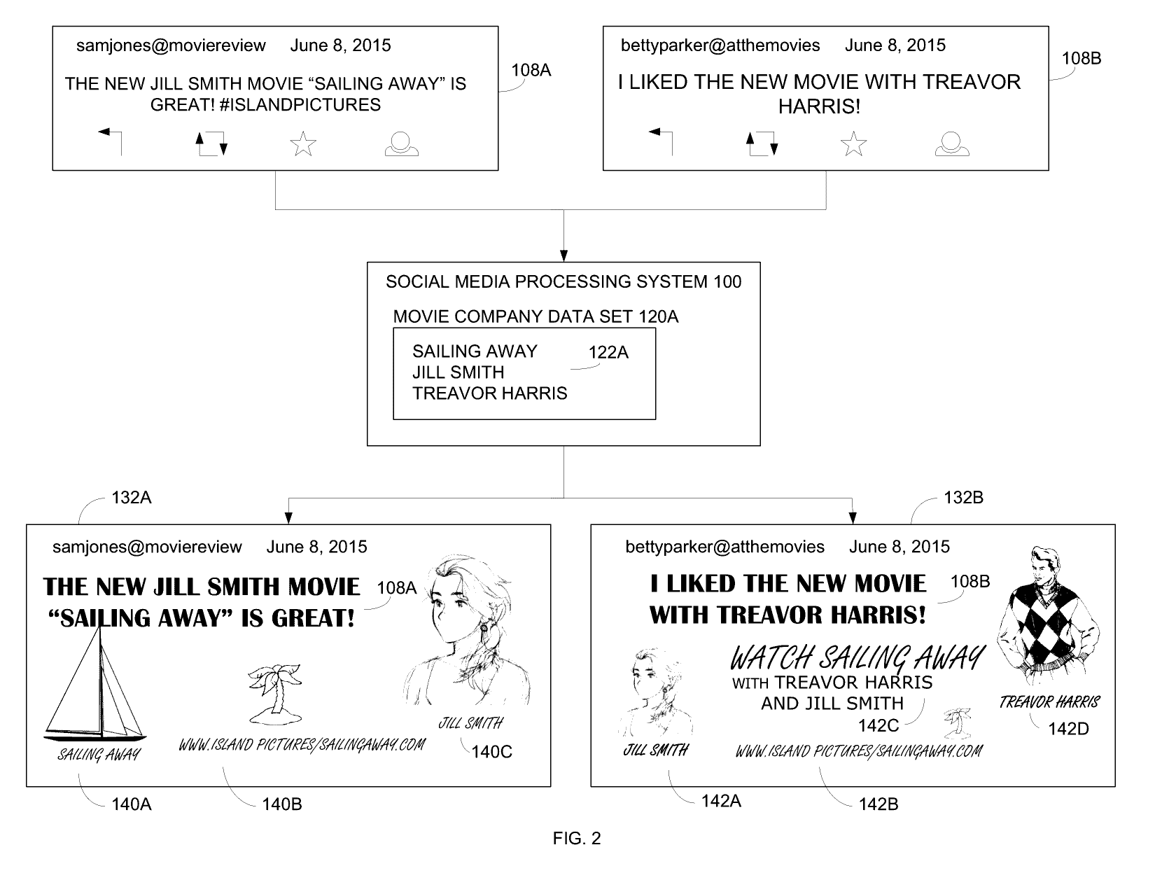

FIG. 2 shows another example of how the processing system may add enhancements to social media. In this example, a movie company may create a data set 120A within social media processing system 100 with keywords and associated rules 122A including the name of a movie and names of actors in the movie. Processing system 100 may collect social media posted on the movie company social network accounts or any other social media that mentions the movie, movie company, actors in the movie, or any other associated context.

In this example, a user may post a message 108A stating: THE NEW JILL SMITH MOVEL “SAILING AWAY” IS GREAT! The user may post message 108A on one of the social media accounts for the movie company that distributes the movie or may have referenced the movie name or movie company name in a hashtag.

Processing system 100 compares keywords 122A with the terms in message 108A and identifies matches for the movie name SAILING AWAY and the actor name JILL SMITH. Data set 120A may include a first rule that directs processing system 100 to add an image 140A from the movie and add an image 140B with the name and logo of the movie company based on the movie name match. The first rule also may specify a particular font to use for message 108A.

Based on the keyword match with actor name JILL SMITH, data set 120A may include a second rule that directs processing system 100 to add image 140C for the actor Jill Smith to message 108A. Thus, resulting enhanced message 132A may have substantially more visual interest than original message 108A.

Processing system 100 may receive another message 108B relating to the same movie including the text: I LIKED THE NEW MOVIE WITH TREAVOR HARRIS! Processing system 100 compares keywords 122A with the terms in message 108B and identifies a match with the actor name Treavor Harris. Data set 120A may include a rule associated with the Treavor Harris keyword 122 that directs processing system 100 to add enhancements 142 to message 108B. In this example, enhancements 142 may include an image 142A of Jill Smith and an image 142D of Treavor Harris.

Enhancements 142 also may include an image 142B of the movie company name and logo. In this example, the rule also may direct processing system 100 to add an advertisement 142C identifying the name of the movie and names of actors in the movie when not already mentioned in message 108B. Thus, processing system 100 may apply different enhancements based on the content in messages 108.

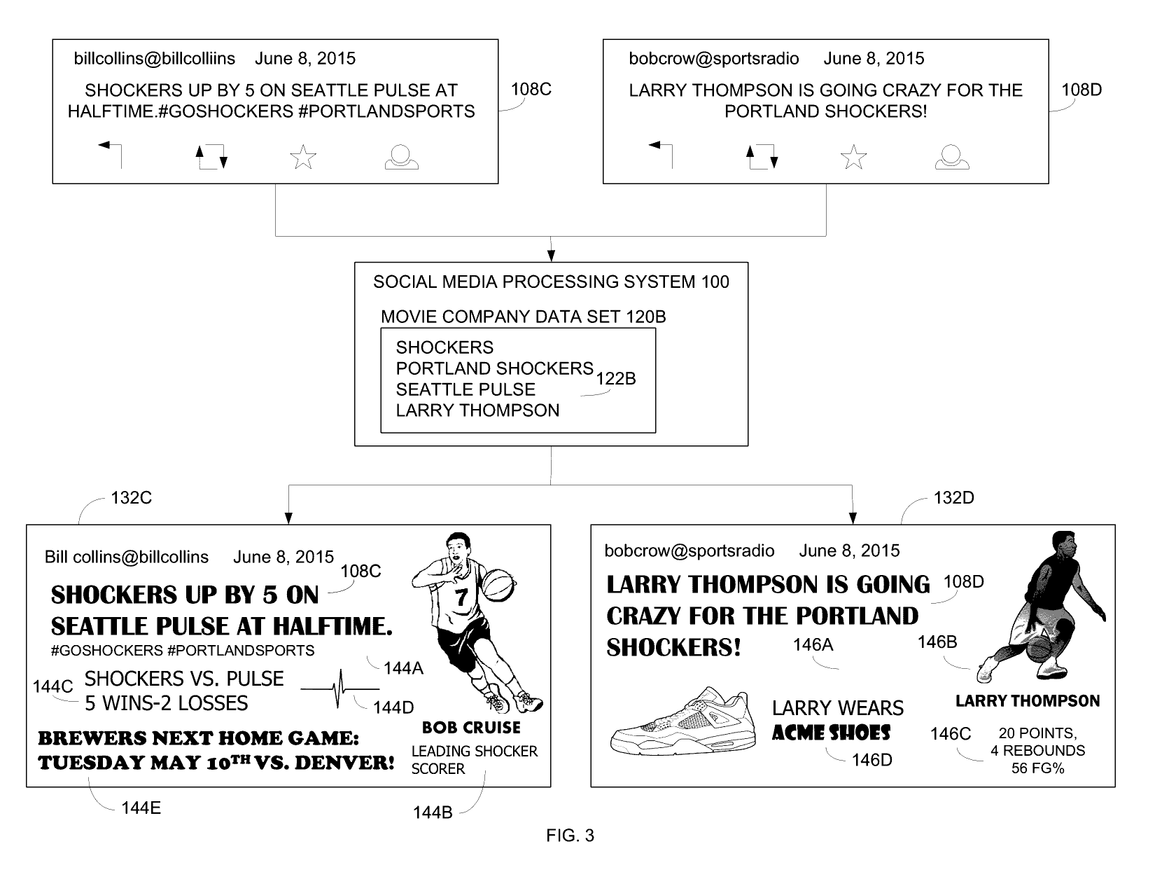

FIG. 3 shows another example of enhancements added to social media. In this example, a sports organization may create a data set 120B in processing system 100 with keywords and associated rules 122B including the name of the basketball team, names of players on the basketball team, and names of other basketball teams. Processing system 100 may collect social media posted on the sports team social network accounts or any other social media that mentions the basketball team, players on the basketball team, other basketball teams, or any other associated context.

In this example, a sports fan may post a message 108C stating: SHOCKERS UP BY 5 ON SEATTLE PULSE AT HALFTIME. Processing system 100 compares keywords 122B with the terms in message 108C and identifies matches both for the sports team Shockers and for another sports team Seattle Pulse that is currently playing the Shockers.

Matches of keywords 122B may include an associated rule that directs processing system 100 to add enhancements 144 to message 108C. Enhancements 144 may include a logo 144A for the basketball team and an image 144B of a leading scorer for the basketball team. Enhancements 144 also may include a picture of Portland that processing system 100 adds as background to message 108C when message 108C also includes the term Portland.

Processing system 100 may receive message 108C during a basketball game with the Seattle Pulse. Based either on the coinciding times of the basketball game and message 108C and/or based on message 108C also mentioning the Seattle Pulse basketball team, a rule in data set 120B may direct processing system 100 to include a current record 144C between the two basketball teams and also may include an image 140D of the opposing team logo.

Data set 120B also may include the current score of the basketball game. In this example, the rule in data set 120B also may display data 144E identifying a next home game for the Portland Shockers. Thus, enhancements 144 provide additional information regarding current and future events associated with the sports team mentioned in message 108C.

Processing system 100 may receive another message 108D stating: LARRY THOMPSON IS GOING CRAZY FOR THE PORTLAND SHOCKERS! Processing system 100 compares keywords 122B with the words in message 108D and identifies a match with the basketball team name Shockers and the basketball player name Larry Thompson. Based on the two matches another rule in data set 122B may direct processing system 100 to add a different set of enhancements 146 to message 108C.

In this example, enhancements 146 may include an image 146A of the team logo, an image 146B of the player mentioned in message 108D, and statistics 146C for the player mentioned in message 108D. Statistics 146C may include statistics of the mentioned player either for the year or for the current basketball game with the Seattle Pulse. Enhancements 146 also may include an advertisement 146D for a product endorsed by the player mentioned in message 108D. Thus, enhancements 146 also provide additional information regarding a specific person mentioned in message 108D.

In another example, different brand names may be associated with different sports. Data set 120B may contain different sport images associated with the different brand names. For example, a first brand name may be associated with basketball and a second band name may be associated with golfing. Data set 120B may include a first keyword 122B for the first brand name that includes an associated image of a basketball player and include a second keyword 122B for the second brand name that includes an associated image of a golfer.

In another example, a user may post a self picture (selfie) with an attached message that mentions a sports figure. Processing system 100 may add a picture of the mentioned sports figure to the posted message.

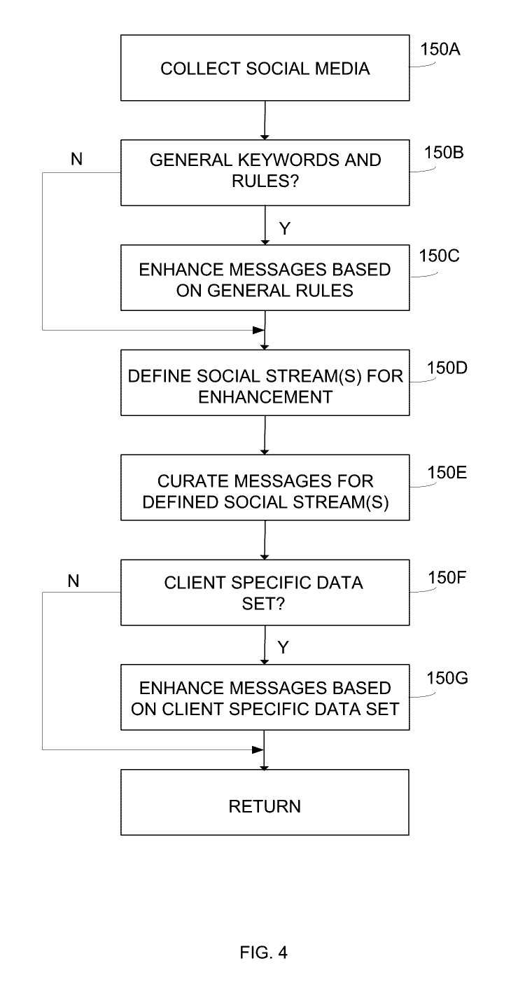

FIG. 4 shows one example process performed by the social media processing system. In operation 150A, the processing system collects social media from different social networks. For example, the processing system may collect messages posted on different accounts on different messaging services, such as Twitter®, Facebook®, Instagram®, Google®, etc.

In operation 150B, the processing system may contain a general set of keywords and rules and add a general set of enhancements to any message with matching terms. For example, the processing system in operation 150C may add the heart image shown in FIG. 1 to any messages that include a positive endorsement term, such like, love, admire, happy, etc.

In operation 150D, the processing system may define different social streams for additional enhancements. For example, an operator may configure the processing system to identify messages posted on particular accounts or that include a particular hashtag.

In operation 150E, the processing system may curate the messages for the defined social streams. For example, an operator, or the enhancement manager 112 in FIG. 1, may select different messages from the social streams for displaying on a display screen.

In operation 150F, the processing system may determine if a second client specific data set exists for applying to the curated messages. For example, a client may create a data set with a specific set of keywords and rules for applying to messages associated with a particular product, event, day, location, or any other criteria.

In operation 150G, the processing system enhances the curated messages based on the client specific data set. For example, the second data set may include a set of rules that direct the processing system to add corporate specific, product specific, location specific, date specific, time specific, and/or event specific enhancements to the messages based on different matching keywords.

The second data set also may have different sets of keyword, rules, and images for different time periods. For example, the second data set may direct the processing device to use a first set of keywords, rules, and images for a first time period and use a second set of keywords, rules, and images for a second time period.

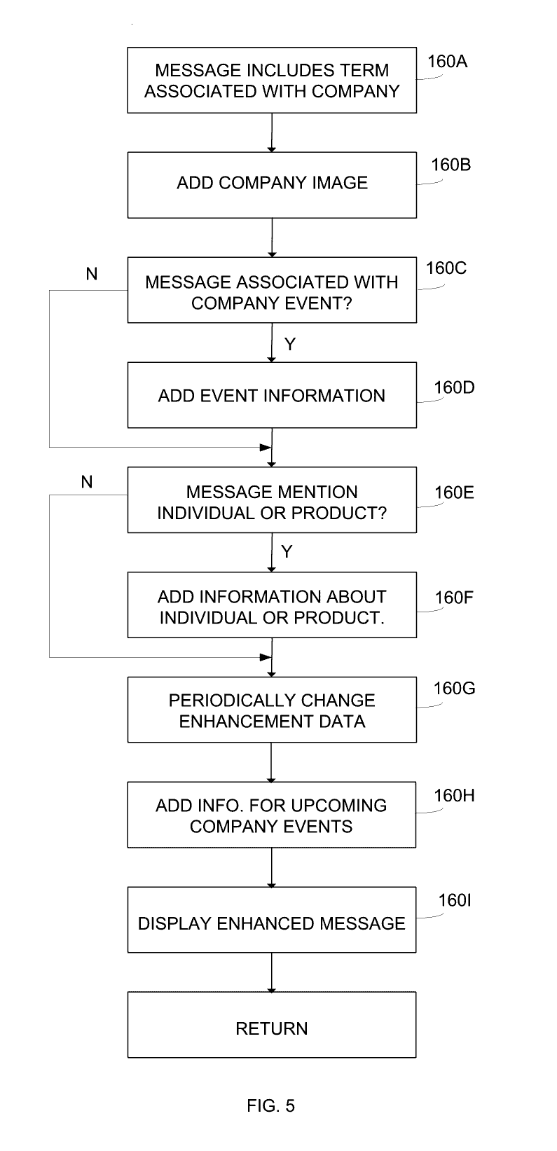

FIG. 5 shows one example set of rules that a data set may use for enhancing social media. This of course is just one example of an almost limitless combination of keywords, rules and images that may be applied to a social media message.

In operation 160A, the processing system may identify a message including a term associated with a company. For example, the message may mention the name of the company or the name of a product sold by the company. In operation 160B, the processing system may add a company image to the message. For example, the processing system may add a company logo or add an image of a company product to the message.

In operation 160C, the processing system may determine if the message is associated with a particular event. For example, the data set may associate a set of keywords with event specific information. The processing system in operation 160D may add event information to any messages associated with the event. For example, processing system may add a picture from the event or add information about the event, such as where and when the event in taking place.

In operation 160E, the message may mention a participant or product associated with the event. For example, the message may mention a speaker at the product launch event or a player in a sporting event. In operation 160F, the processing system may add information to the message about the event participant or product. For example, the processing system may add an image of the speaker and/or add information about the speaker.

In operation 160G, the processing system may periodically change the enhancement data. For example, the data set may have different sets of images associated with the same keywords. To prevent enhanced messages from becoming stale, the data set rules may cause the processing system to use different sets of images for different time periods. For example, a first company logo may be added to messages in the morning and a second company logo, advertisement, and/or image may be added to messages in the afternoon.

In operation 160H, the processing device may add any other information associated with the matching keywords, such as information regarding upcoming events. In operation 1601, the processing device displays the enhanced message on a display screen.

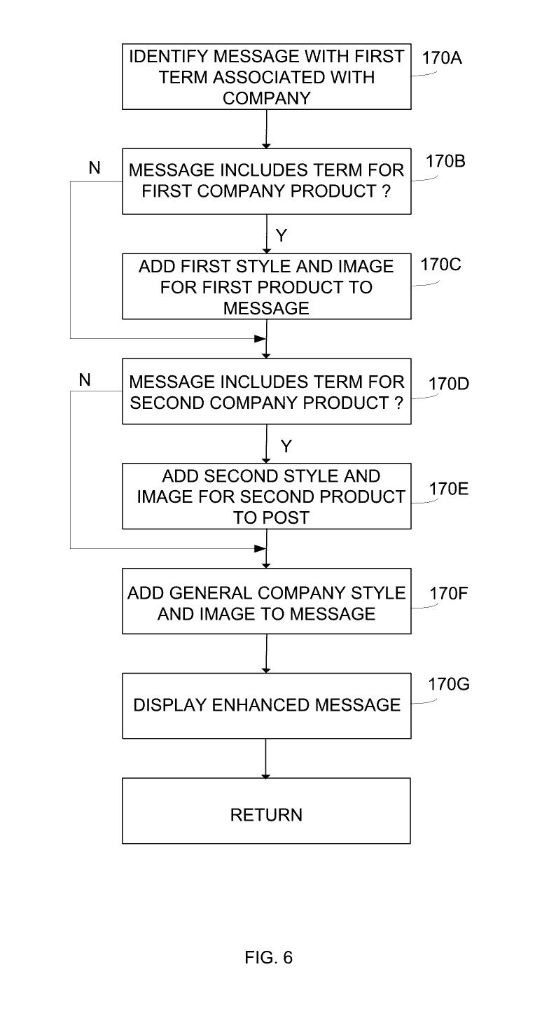

FIG. 6 shows another example of rules that a data set may use to enhance social media. In operation 170A, the processing system may identify a message that contains a first term associated with a particular company, such as the term Acme.

In operation 170B, the processing system may search for a second term associated with a first product sold by the company, such as Diet Acme. If the second term is identified, the processing system in operation 170C may add a first style and image to the message associated with the first product. For example, the processing system may add a silver and black background to the message that corresponds with the colors on an Acme diet soda can and also may add an image of the Acme diet soda can.

In operation 170D, the processing system may search for a term associated with a second product sold by the company, such as Orange Acme. If the third term is identified, the processing system in operation 170E may add a second style and image to the message associated with the second product. For example, the processing system may add a second orange and white background image to the message that corresponds with the colors on Acme orange soda cans and also may include an image of the Acme orange soda can.

In operation 170F, the processing system may add a general company style and image to the message. For example, the processing system may add a general logo or background used on all Acme products. In operation 170G, the processing system then displays the enhanced message on a display device. These of course are just a few examples of rules used by the processing system to enhance social media.

Thus, the enhanced social media may create additional visual connections between viewers and the subject matter referred to in social media messages.
Hardware and Software

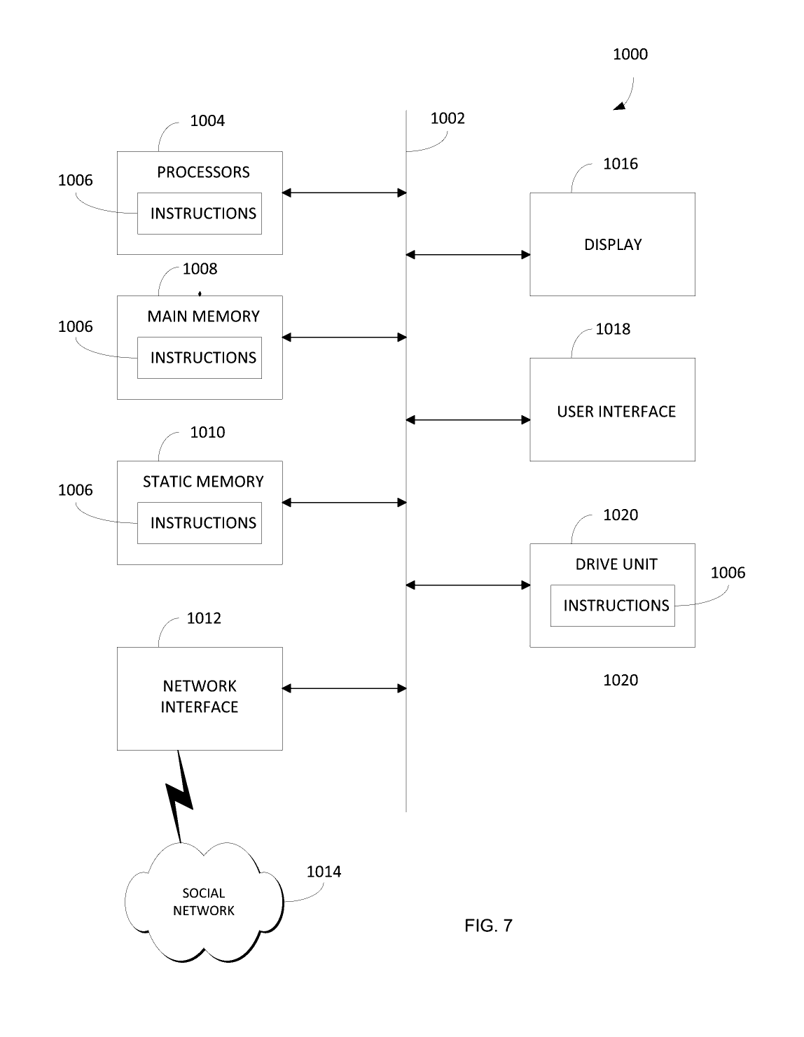

FIG. 7 shows a computing device 1000 that may be used for operating computing devices in the social media processing system and performing any combination of processes discussed above. The computing device 1000 may operate in the capacity of a server or a client machine in a server-client network environment, or as a peer machine in a peer-to-peer (or distributed) network environment. In other examples, computing device 1000 may be a personal computer (PC), a tablet, a Personal Digital Assistant (PDA), a cellular telephone, a smart phone, a web appliance, or any other machine or device capable of executing instructions 1006 (sequential or otherwise) that specify actions to be taken by that machine.

While only a single computing device 1000 is shown, the computing device 1000 may include any collection of devices or circuitry that individually or jointly execute a set (or multiple sets) of instructions to perform any one or more of the operations discussed above. Computing device 1000 may be part of an integrated control system or system manager, or may be provided as a portable electronic device configured to interface with a networked system either locally or remotely via wireless transmission.

Processors 1004 may comprise a central processing unit (CPU), a graphics processing unit (GPU), programmable logic devices, dedicated processor systems, micro controllers, or microprocessors that may perform some or all of the operations described above. Processors 1004 may also include, but may not be limited to, an analog processor, a digital processor, a microprocessor, multi-core processor, processor array, network processor, etc.

Some of the operations described above may be implemented in software and other operations may be implemented in hardware. One or more of the operations, processes, or methods described herein may be performed by an apparatus, device, or system similar to those as described herein and with reference to the illustrated figures.

Processors 1004 may execute instructions or “code” 1006 stored in any one of memories 1008, 1010, or 1020. The memories may store data as well. Instructions 1006 and data can also be transmitted or received over a network 1014 via a network interface device 1012 utilizing any one of a number of well-known transfer protocols.

Memories 1008, 1010, and 1020 may be integrated together with processing device 1000, for example RAM or FLASH memory disposed within an integrated circuit microprocessor or the like. In other examples, the memory may comprise an independent device, such as an external disk drive, storage array, or any other storage devices used in database systems. The memory and processing devices may be operatively coupled together, or in communication with each other, for example by an I/O port, network connection, etc. such that the processing device may read a file stored on the memory.

Some memory may be “read only” by design (ROM) by virtue of permission settings, or not. Other examples of memory may include, but may be not limited to, WORM, EPROM, EEPROM, FLASH, etc. which may be implemented in solid state semiconductor devices. Other memories may comprise moving parts, such a conventional rotating disk drive. All such memories may be “machine-readable” in that they may be readable by a processing device.

“Computer-readable storage medium” (or alternatively, “machine-readable storage medium”) may include all of the foregoing types of memory, as well as new technologies that may arise in the future, as long as they may be capable of storing digital information in the nature of a computer program or other data, at least temporarily, in such a manner that the stored information may be “read” by an appropriate processing device. The term “computer-readable” may not be limited to the historical usage of “computer” to imply a complete mainframe, mini-computer, desktop, wireless device, or even a laptop computer. Rather, “computer-readable” may comprise storage medium that may be readable by a processor, processing device, or any computing system. Such media may be any available media that may be locally and/or remotely accessible by a computer or processor, and may include volatile and non-volatile media, and removable and non-removable media.

Computing device 1000 can further include a video display 1016, such as a liquid crystal display (LCD) or a cathode ray tube (CRT)) and a user interface 1018, such as a keyboard, mouse, touch screen, etc. All of the components of computing device 1000 may be connected together via a bus 1002 and/or network.

For the sake of convenience, operations may be described as various interconnected or coupled functional blocks or diagrams. However, there may be cases where these functional blocks or diagrams may be equivalently aggregated into a single logic device, program or operation with unclear boundaries.

Having described and illustrated the principles of a preferred embodiment, it should be apparent that the embodiments may be modified in arrangement and detail without departing from such principles. Claim is made to all modifications and variation coming within the spirit and scope of the following claims.

1. A method, comprising:
collecting, by a processing system, social media from different social networks;
identifying, by the processing system, a message in the social media associated with a client;
identifying, by the processing system, a data set associated with the client that includes keywords and associated rules;
identifying, by the processing system, terms in the message matching one or more of the keywords;
adding, by the processing system, enhancements to the message based on the rules associated with the matching keywords; and
displaying, by the processing system, the message with the enhancements;

2. The method of claim 1, further comprising:
storing, by the processing system, in the data set a group of images;
adding, by the processing system, the images as part of the enhancements to the message based on the rules associated with the matching keywords.

3. The method of claim 1, further comprising:
identifying, by the processing system, a first one of the terms in the message matching a first one of the keywords;
adding, by the processing system, a first enhancement to the message based on a first one of the rules associated with the first one of the keywords;
identifying, by the processing system, a second one of the terms in the message matching a second one of the keywords;
adding, by the processing system, a second enhancement to the message based on a second one of the rules associated with the second one of the keywords.

4. The method of claim 1, further comprising:
identifying, by the processing system, a company name in the message;
identifying, by the processing system, a company logo in the data set associated with the company name; and
adding, by the processing system, the company logo as part of the enhancements to the message.

5. The method of claim 4, further comprising:
identifying, by the processing system, a sponsor logo in the data set associated with the company name; and
adding, by the processing system, the sponsor logo as part of the enhancements to the message.

6. The method of claim 1, further comprising:
identifying, by the processing system, a name of a person in the message;
identifying, by the processing system, an image of the person in the data set; and
adding, by the processing system, the image of the person as part of the enhancements to the message.

7. The method of claim 6, further comprising:
identifying, by the processing system, personal information for the person mentioned in the message; and
adding, by the processing system, the personal information for the person as part of the enhancements to the message.

8. The method of claim 6, further comprising:
identifying, by the processing system, a sponsor logo in the data set for a product endorsed by the person; and
adding, by the processing system, the sponsor logo as part of the enhancements to the message.

9. The method of claim 1, further comprising:
identifying, by the processing system, a positive endorsement term in the message;
identifying, by the processing system, an image in the data set representing the positive endorsement term; and
adding, by the processing system, the image as part of the enhancements to the message.

10. The method of claim 1, further comprising:
storing, by the processing system, a first set of general enhancements associated with a first set of keywords;
storing, by the processing system, a second set of company specific enhancements associated with a second set of keywords;
identifying, by the processing system, a first one of the terms in the message matching one of the first set of keywords;
adding, by the processing system, one of the first set of general enhancements associated with the matching one of the first set of keywords to the message;
identifying, by the processing system, a second one of the terms in the message matching one of the second set of keywords;
adding, by the processing system, one of the second set of company specific enhancements associated with the matching one of the second set of keywords to the message.

11. A processing system, comprising:
a processing device configured to:
identify a post associated with a company;
identify a data set associated with the company;
identify a word or image in the post that matches a keyword in the data set;
identifying a rule in the data set associated with the matching keyword;
add an enhancement from the data set to the post based on the identified rule; and
render the post with the enhancement.

12. The processing system of claim 11, wherein the enhancement includes a logo associated with the company.

13. The processing system of claim 11, wherein the processing device is further configured to:
identify a name of a person mentioned in the post;
identify an image of the person in the data set; and
add the image of the person as part of the enhancement to the post.

14. The processing system of claim 13, wherein the processing device is further configured to:
identify statistics in the data set for the person mentioned in the post; and
add the statistics as part of the enhancement to the post.

15. The processing system of claim 11, wherein the processing device is further configured to:
identify information associated with an event hosted by the company based on the identified rule; and
add the information as part of the enhancement to the post.

16. The processing system of claim 15, wherein the processing device is further configured to:
identify a name of a person in the post associated with the event; and
add an image of the person as part of the enhancement to the post.

17. The processing system of claim 11, wherein the processing device is further configured to periodically change the enhancement from the data set added to the post based on the identified rule.
